(19) United States
(12) Patent Application Publication
(10) Pub. No.: US 2003/0187767 A1
(43) Pub. Date: Oct. 2, 2003

(54) Optimal allocation of budget among marketing programs

(76) Inventors: Robert Crites, Hummelstown, PA (US); Yuchun Lee, Sudbury, MA (US); Ruby L. Kennedy, Bedford, MA (US)

Correspondence Address: FISH & RICHARDSON PC, 225 FRANKLIN ST, BOSTON, MA, 02110, US

(21) Appl. No.: 10/113,905

(22) Filed: Mar. 29, 2002

(51) Int. Cl. G06F 17/60

(52) U.S. Cl. 705/35

(57) ABSTRACT

Techniques for optimizing budget allocations among a plurality of marketing campaigns are described. The techniques include providing an expected return on investment (ROI) for potential contacts in target populations for each of a plurality of marketing campaigns and ordering the potential contacts by ROI for the marketing campaigns. The techniques also include determining a threshold ROI satisfying an overall budget, where potential contacts with ROI greater than the threshold level are recommended for actual contact.

### BACKGROUND

This invention relates to marketing campaign optimization.

Organizations often conduct multiple marketing campaigns. With multiple marketing campaigns monetary resources are assigned to each of the campaigns and the campaigns are conducted within budgets. One outcome that is desired is to facilitate the highest possible profit. Response models are currently used to prioritize the contacts that should be made by a given campaign so that the most profitable prospects have a higher priority of being contacted for each campaign.

### SUMMARY

In general, not all possible contacts for a campaign have the same likelihood of response or expected degree of profitability. This invention seeks to prioritize contacts across all the campaigns. If such a prioritization has been performed, the value of additional monetary resources applied to a marketing campaign depends upon how many of the best prospects have already been included within the budget of the campaign. Determining the optimal allocation of budget across multiple campaigns is made difficult by this dependence of the value of additional resources for each campaign on the size of the campaign. In most cases there is a maximum overall budget, and some individual campaigns may have to be restricted from reaching their highest possible profit, because even greater profits per additional invested dollars are available from other campaigns.

According to an aspect of the present invention, a method for optimizing budget allocation among marketing campaigns includes providing an expected return on investment (ROI) for potential contacts in target populations for each of a plurality of marketing campaigns and ordering the potential contacts by ROI for the marketing campaigns. The method also includes determining a threshold ROI satisfying an overall budget, where potential contacts with ROI greater than the threshold level are recommended for actual contact.

According to an additional aspect of the present invention, a computer program product resides on a computer readable medium. The program optimizes budget allocation among marketing campaigns and includes instructions for causing a processor to estimate an expected return on investment (ROI) for potential contacts for each of a plurality of marketing campaigns. The program also includes instructions to order the potential contacts by ROI for the marketing campaigns and determine a threshold ROI satisfying an overall budget, where potential contacts with ROI greater than the threshold level are recommended for actual contact.

One or more aspects of the invention may provide one or more of the following advantages.

The invention provides a process for optimal allocation of a budget across multiple marketing campaigns. The invention deals with the situation where possible contacts for each campaign have been prioritized, and where the value of additional monetary resources thus depends on the size of the marketing campaigns. The invention can use response models or other data models, formulas, or simulations to determine the expected profitability of potential contacts. The invention orders contacts by expected return on investment (ROI) across all the campaigns, and determines an ROI threshold corresponding to a given overall budget. By optimizing across multiple campaigns higher profitability can be achieved than would be possible by assigning arbitrary budgets to the marketing campaigns, even if the resulting campaigns were optimized individually.

Other possible advantages of the invention include the ability to determine a relationship between the overall budget level and the threshold ROI (or other measures such as profitability) and graphically display the relationships. “What-if” scenarios regarding increases or decreases in overall budget can be evaluated. The optimal overall budget can be solved, along with the optimal percentages allocated to each of the marketing campaigns.

### DESCRIPTION OF DRAWINGS

FIG. 1 is a block diagram of a computer system executing marketing strategy optimization software including response modeling software and budget allocation software.

FIG. 2 is a block diagram of datasets of records.

FIG. 2A is a diagram of a record.

FIG. 3 is a flow chart of a budget allocation process.

FIG. 4 is a diagram depicting an example of a graphic output of the budget allocation process.

FIG. 5 is a block diagram depicting a dataset and the dataset sorted according to alternative strategies.

FIGS. 6A-6B are block diagrams of datasets representing campaigns including a mass media campaign.

### DETAILED DESCRIPTION

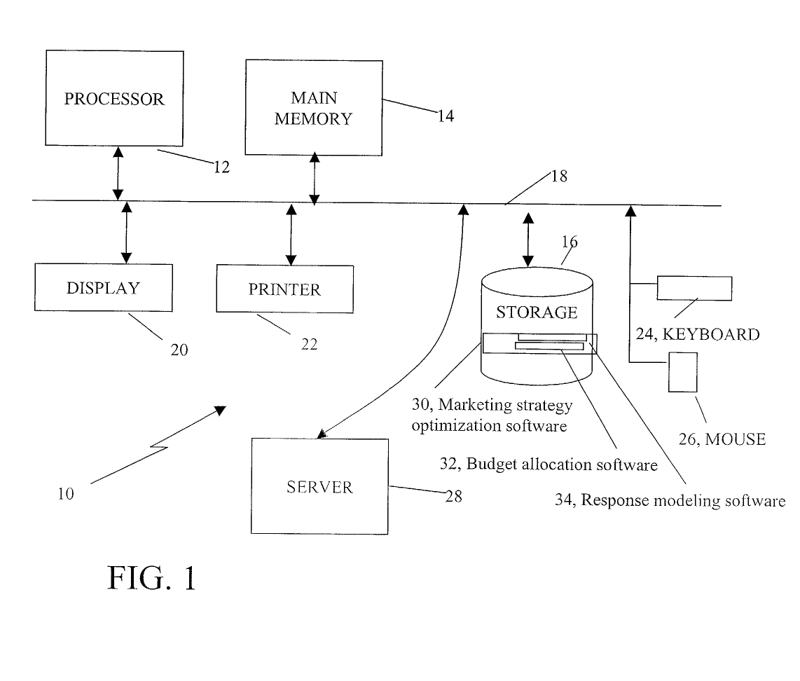

Referring now to FIG. 1, a computer system 10 includes a CPU 12, main memory 14 and persistent storage device 16 all coupled via a computer bus 18. The system 10 also includes output devices such as a display 20 and a printer 22, as well as user-input devices such as a keyboard 24 and a mouse 26. Not shown in FIG. 1 but necessarily included in a system of FIG. 1 are software drivers and hardware interfaces to couple all the aforementioned elements to the CPU 12.

The computer system 10 also includes marketing strategy optimization software 30 that includes budget allocation software 32. The budget allocation software 32 determines an optimal allocation of budgets among multiple marketing programs. The budget allocation software 32 finds the most profitable way of dividing a fixed budget among multiple marketing programs and also allows execution of “what-if” type analysis that can measure the effect of increases or decreases in the overall budget on program allocations, profitability, return on investment, and other measures that may be used to determine the effectiveness of a marketing program. The budget allocation software 32 also uses response-modeling software 34 that models the expected behavior of potential customers in response to the various marketing programs.

The marketing strategy optimization software 30, budget allocation software 32, and response modeling software 34, may reside on the computer system 10, as shown, or may reside on a server 28 that is coupled to the computer system 10 in a conventional client-server arrangement. The details on how this marketing strategy optimization software 30, budget allocation software 32, and response modeling software 34 are coupled to this computer system 10 are not important to understand the present invention.

Generally, response modeling software 34 executes complex data modeling algorithms such as linear regression, logistic regression, back propagation neural network, Classification and Regression Trees (CART) and Chi-squared Automatic Interaction Detection (CHAID) decision trees, as well as other types of algorithms that operate on a data set. One of the results returned by the response modeling software 34 could include a predicted or expected profit that can result from sending a particular offer to a particular customer or potential customer or contact. Expected profits can be modeled directly by the response modeling software 34, or indirectly, in which case the raw model scores may be converted into profit predictions, for example by converting the raw scores into response probabilities, multiplying by the expected revenue given a response, and subtracting the costs associated with the customer.

Early in the process of strategic planning of marketing programs and in various other situations, response models may not yet be available. In such situations, response models can be simulated. For example, given a particular parametric form for the shape of a lift curve of the model to be simulated, the expected overall response rate, and the area under the lift curve, a set of simulated model scores may be generated and used.

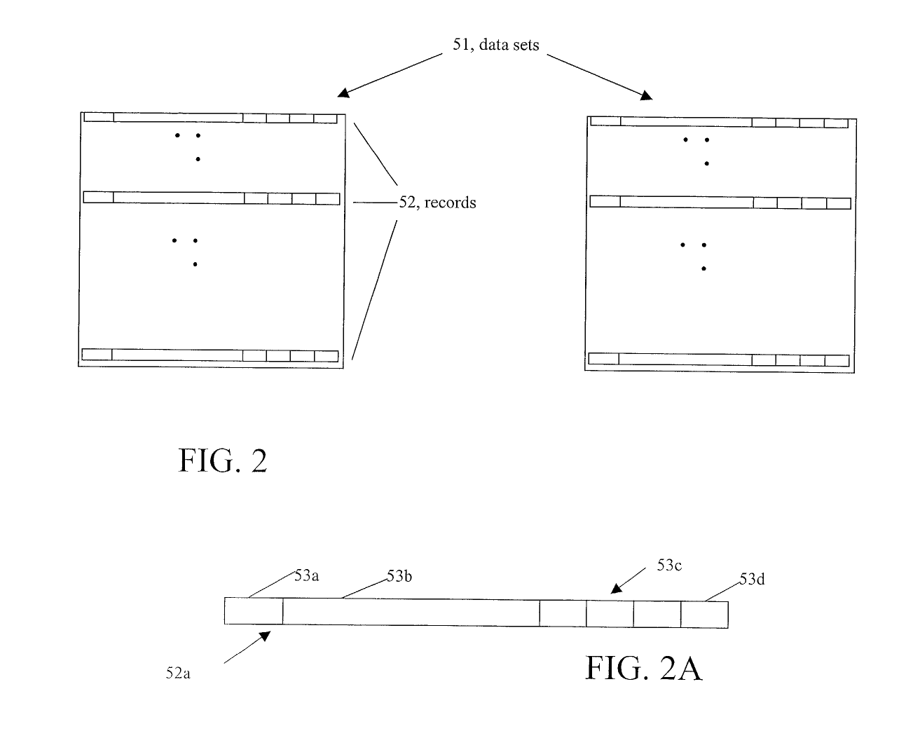

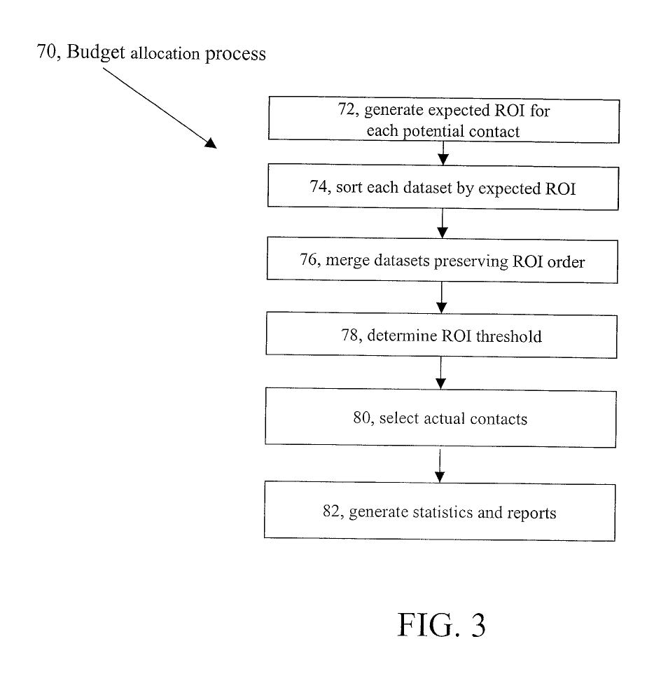

Referring now to FIGS. 2 and 2A, datasets 51 are determined for each of a plurality of marketing programs. Each of the datasets 51 includes a plurality of records 52. Each record 52 has information about a possible contact for that marketing program. The information is stored in fields within the record. The records 52 can include an identifier field 53a, a cost per contact field 53b, and fields 53c containing other information about possible customers. In addition, the records 52 contain one or more result fields 53d that measure the expected behavior for that possible contact in response to that marketing program. One of the result fields 53d is the expected profit. The result fields 53d, including the expected profit, may be derived from the response modeling software 34, or other techniques such as Heckman's two-stage models, other methods that directly model real-valued outputs, or other types of formulas or models. A response model scores the contacts producing a response probability for each of the contacts. The response probabilities together with expected revenue, cost for each of the campaigns, and cost per contact are used to determine expected return on investment (ROI) for each possible contact within each of the campaigns. A model scores the contacts producing a response probability for each of the contacts.

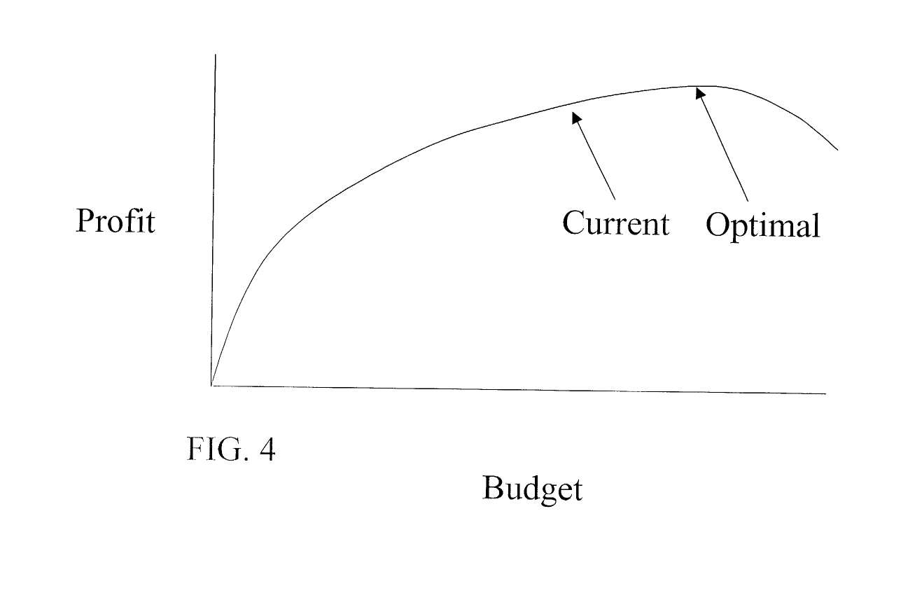

Referring now to FIG. 3, the budget allocation software 32 includes a process 70 for prioritizing contacts and allocating budget among marketing programs. Once the expected return on investment has been generated for each possible contact of each marketing program, the budget allocation software 32 prioritizes the contacts across all of the marketing programs in order to maximize profitability and return on investment (ROI) across all of the marketing programs. The process 70 requires, as input, the cost per contact and expected profit fields from the datasets 51 associated with each marketing program. The expected ROI is generated 72 for each record by dividing the expected profit by the cost per contact. Each dataset 51 is sorted 74 by expected ROI. The records from the sorted datasets are merged 76, while preserving their ordering by expected ROT. A threshold ROT is determined 78 by selecting the records in order beginning with the highest ROI and continuing until the cumulative cost per contact associated with the selected records reaches the maximum overall budget. Out of all the possible contacts for each marketing program, those with ROT above the threshold are selected 80 to become actual contacts. Statistics for each marketing program can be generated 82 based on the actual contacts including the amount of budget allocated, the number of contacts, the expected number of responses, profitability, and ROI.

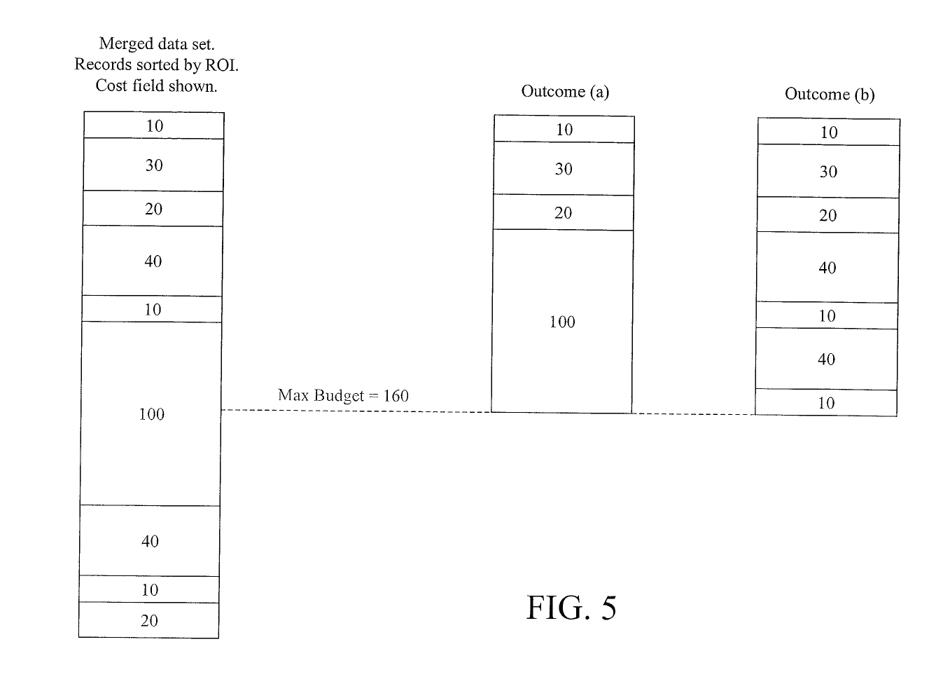

Other uses for the budget allocation software 32 include the ability to experiment with what-if type scenarios. For example, the marketing strategy optimization software 30 may use the budget allocation software 32 to produce reports showing the results of increasing or decreasing the overall budget on the profitability or other measures for each marketing program or across all marketing programs. One such report could be a graphic display, as shown in FIG. 4, with budget as the x-axis and profit as the y-axis and a curve showing their relationship. The points along the curve can be generated from the output of the merging step 76, with the cumulative effect of each record or block of records corresponding to a point on the curve.

In addition to direct type marketing type campaigns, these techniques can be used in other types of marketing type campaigns such as brand management and mass media type advertisements where a user would not know exactly who is exposed to advertising and so forth. In those situations, response rates for a target population would be estimated in lieu of determining individual scores. One technique to estimate response rates would involve using different types of inputs that are aggregated for a population to determine averages across target populations. The estimated response rate would be used to determine ROI. The technique can be used to specify a finite population and anticipated response rate so that mass media type campaigns can be compared against campaigns for which a user has individual response probabilities. The technique can be used in event management and so forth. Essentially in these types of budget optimizations it is desirable to be able to deal with the all-or-nothing nature of mass media and to be able to adjust the budget on mass media.

Certain types of marketing campaigns, such as mass media campaigns or events have an all or nothing nature. For example, an organization may choose to either run or not run a particular radio advertisement that costs $5000, but cannot adjust the budget to intermediate values to target an exact number of responses as would be possible in more incremental types of campaigns that use response modeling such as direct mail or telemarketing.

The process 70 handles campaigns of this type by considering all the potential contacts from a mass media campaign to be treated as a single (target population) “contact.” The cost per contact is the entire cost of the campaign, and the expected revenue, profitability, and ROI are also computed for the mass media campaign as a whole. Since the cost per contact in mass media campaigns is of a much higher magnitude than in incremental campaigns, it becomes important for 78 (determining a threshold ROI) to deal with the situation where a record is selected whose cost per contact can only be partially accommodated within the remaining overall budget. The way this is handled is during 78 to select the most profitable between two possible outcomes for the record whose cost can only be partially accommodated:

(a) Include that record, and delete as many of its immediate predecessors as necessary to remain within the overall budget.

(b) Remove that record, and then continue adding its successors until the budget is exhausted.

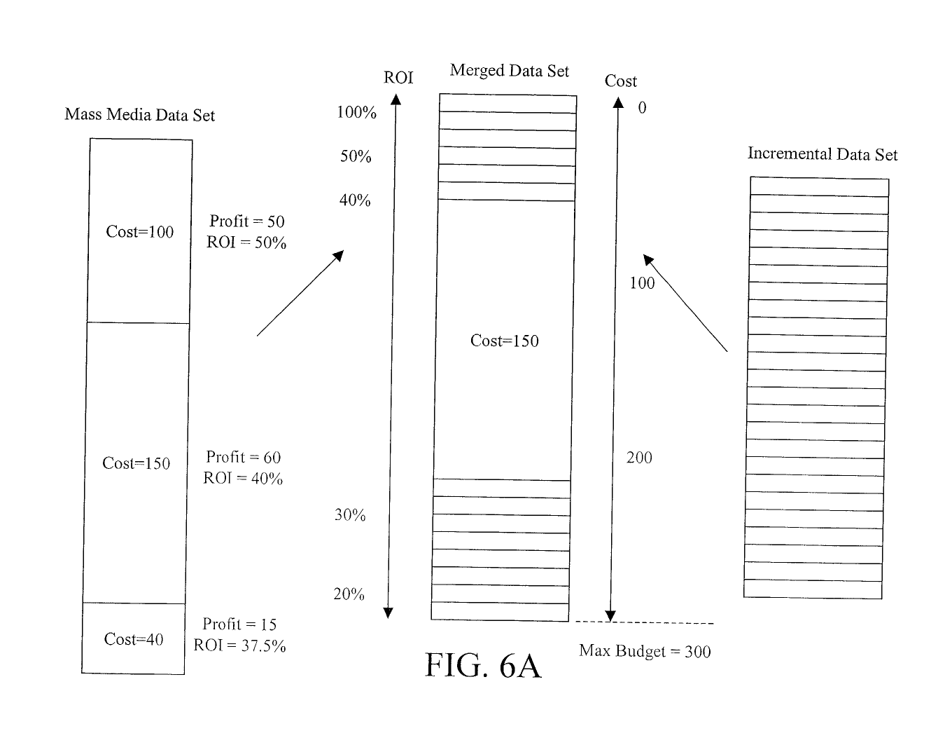

Referring to FIG. 5 an example of these two choices is shown. A merged data set having records sorted by ROI with cost fields is displayed. The dataset is sorted according to each of the examples above.

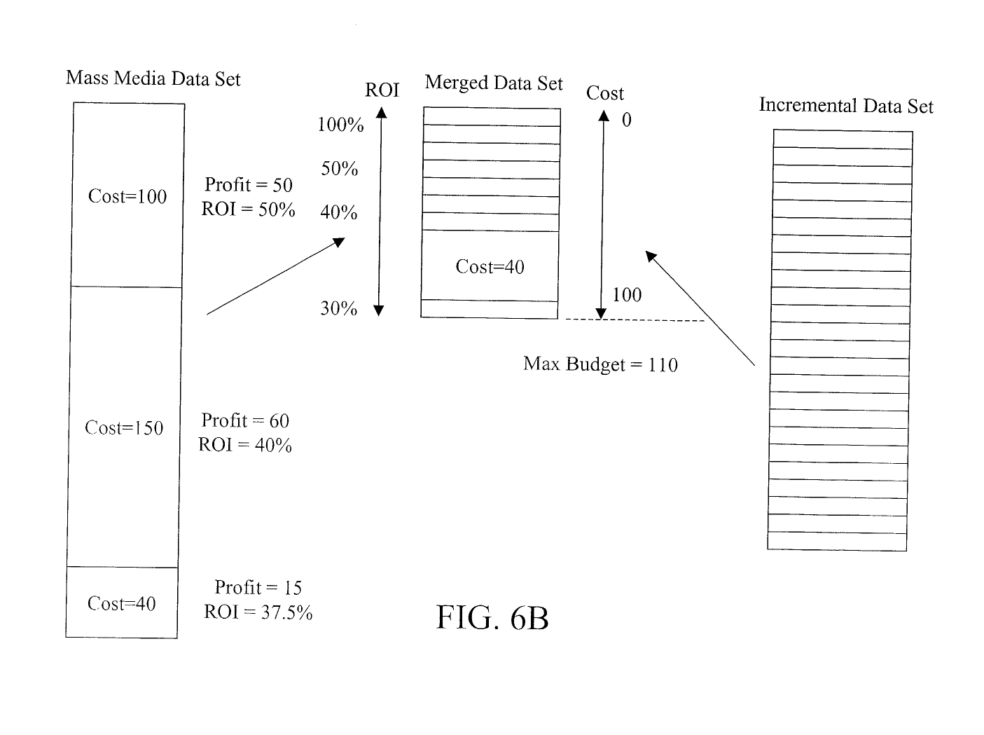

Referring to FIGS. 6A and 6B, the process 70 also handles the situation where some variations in budget are possible for mass media campaigns. For example, it may be possible to run multiple advertisements, or to vary their length or production quality. Each possible budget level corresponds to a record 52 and is evaluated as to its cost, expected revenue, profit, and ROI. The dataset 51 for the mass media campaign is sorted in order of decreasing ROI. The difference from incremental campaigns is that at most one record from a mass media dataset is allowed to be selected.

If there is a sufficiently large overall budget (FIG. 6A) to select the mass media record 52 with highest ROI, that record can be displaced by one farther down in the dataset 51 only if the record with lower ROI has a higher profit and would also fit within the overall budget. If there are not enough resources in the overall budget (FIG. 6B) to accommodate the mass media record 52 with highest ROI, then a record farther down in the dataset 51 can be selected if its cost fits within the overall budget.

Other embodiments are within the scope of the appended claims.

What is claimed is:

1. A method for optimizing budget allocation among marketing campaigns comprises:
providing an expected return on investment (ROI) for potential contacts in target populations for each of a plurality of marketing campaigns;
ordering the potential contacts by ROI for the marketing campaigns; and
determining a threshold ROI satisfying an overall budget, where potential contacts with ROI greater than the threshold level are recommended for actual contact.

2. The method of claim 1 wherein response models, data models, formulas, or simulations are used, alone or in combination, to estimate the expected ROI for each potential contact.

3. The method of claim 1 wherein the amount of the overall budget is allowed to vary, and a relationship between the overall budget and the threshold ROI is obtained.

4. The method of claim 3 further comprising:
graphically representing a relationship between the overall budget for the plurality of marketing campaigns and overall profitability.

5. The method of claim 3 further comprising:
produce reports showing the results of increasing or decreasing the overall budget on the profitability for each marketing program.

6. The method of claim 3 further comprising:
produce reports showing the results of increasing or decreasing the overall budget on the profitability for each marketing program across all marketing programs.

7. The method of claim 3 wherein the optimal overall budget is determined based on maximizing profit and/or other objectives.

8. The method of claim 1 wherein providing an expected rate of return on investment is provided by estimating a response rate for a target population to provide the expected ROI for the target population.

9. The method of claim 1 wherein some of the contacts are from a mass media campaign and are treated as a single target population contact, with the cost per contact being the entire cost of the campaign, and the expected revenue, profitability, and ROI being computed for the mass media campaign as a whole.

10. A computer program product residing on a computer readable medium for optimizing budget allocation among marketing campaigns comprises instructions for causing a processor to:
estimate an expected return on investment (ROI) for potential contacts for each of a plurality of marketing campaigns;
order the potential contacts by ROI for the marketing campaigns; and
determine a threshold ROI satisfying an overall budget, where potential contacts with ROI greater than the threshold level are recommended for actual contact.

11. The computer program product of claim 10 wherein the computer program further comprises instructions to:
receive inputs from response models or other data models, formulas, or simulations to estimate the expected ROI for each potential contact.

12. The computer program product of claim 10 wherein the amount of the overall budget is allowed to vary, and a relationship between the overall budget and the threshold ROI is obtained.

13. The computer program product of claim 10 further comprising instructions to:
graphically represent a relationship between the overall budget for the plurality of marketing campaigns and overall profitability.

14. The computer program product of claim 10 further comprising instructions to:
produce reports showing the results of increasing or decreasing the overall budget on the profitability for each marketing program.

15. The computer program product of claim 10 further comprising instructions to:
produce reports showing the results of increasing or decreasing the overall budget on the profitability for each marketing program across all marketing programs.
